(19) United States
(12) Patent Application Publication
(10) Pub. No.: US 2025/0053799 A1
(43) Pub. Date: Feb. 13, 2025

(54) CONTEXT-AWARE AND DYNAMIC VISUALIZATIONS IN APPLICATIONS

(71) Applicant: Microsoft Technology Licensing, LLC, Redmond, WA (US)

(72) Inventors: Astha Rastogi, Seattle, WA (US); Ravi Teja Koganti, Bellevue, WA (US); Tania Albarghouthi, Seattle, WA (US); Nathaniel T Clinton, Redmond, WA (US)

(73) Assignee: Microsoft Technology Licensing, LLC, Redmond, WA (US)

(21) Appl. No.: 18/231,064

(22) Filed: Aug. 7, 2023

(51) Int. Cl. G06N 3/08; G06N 3/0475; G06T 11/00

(52) U.S. Cl. CPC G06N 3/08; G06N 3/0475; G06T 11/00; G06T 2200/24

(57) ABSTRACT

The technology relates to systems and methods for generating context-aware, dynamic visualizations. In an example, a method includes extracting a dynamic context signal; based on the dynamic context signal, retrieving a first visualization; causing a display of the first visualization as part of an application user interface; at an expiration of a refresh period, extracting an updated dynamic context signal; based on the updated dynamic context signal, retrieving a second visualization; and replacing the first visualization with the second visualization as part of an application user interface.

### BACKGROUND

Productivity applications are designed to help entities (e.g., individuals and organizations) generate content and data (e.g., electronic communications, schedules, documents, projects) more efficiently. The applications are often hosted and run by the respective operating systems of different types of computing devices. The applications and/or operating system may provide different user interfaces.

It is with respect to these and other considerations that examples have been made. In addition, although relatively specific problems have been discussed, it should be understood that the examples should not be limited to solving the specific problems identified in the background.

### SUMMARY

Examples described in this disclosure relate to systems and methods for generating context-aware, dynamic visualizations that are incorporated into a user interface of an application and/or an operating system. For example, dynamic context signals are extracted from different sources, such as applications operating on the devices, operating systems of the devices, and/or other devices external from the devices performing the dynamic visualization operations discussed herein. The dynamic context signals provide data about the current context of the device, such as location, weather, mailbox state, or other types of context that dynamically change over time. A dynamic visualization may then be generated based on the extracted context signals. For instance, an artificial intelligence (AI) prompt is generated that incorporates the extracted context signals and requests a generative AI model to generate a visualization based on the context signals. The generative AI model processes the AI prompt and generates an output payload that includes the visualization. The visualization is then processed and displayed as part of the user-interface for the application and/or operating system.

After a refresh period has expired, a new visualization is generated if the context signals have changed. Accordingly, the visualization aspect of the application dynamically changes as the context of the device's operation changes. The refresh period may be based on the particular context signals that are being used to generate the visualizations. For example, some context signals are unlikely to change in a frequent manner (e.g., seasons), whereas other context signals change more frequently (e.g., current weather).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of a system in which a context-aware, dynamic visualization system is implemented according to an example.

FIG. 2A is a block diagram of example components of an example context-aware, dynamic visualization system.

FIG. 2B is a block diagram of example components of another example context-aware, dynamic visualization system.

FIG. 3A depicts an example interface including context-aware, dynamic visualizations.

FIG. 3B depicts another example interface including context-aware, dynamic visualizations.

FIGS. 4A-F depicts example context-aware, dynamic banners for inclusion in an application.

FIG. 5 depicts an example method of generating context-aware, dynamic visualizations.

FIGS. 6A-B depicts another example method for generating context-aware, dynamic visualizations.

FIG. 7 is a block diagram illustrating example physical components of a computing device with which aspects of the disclosure may be practiced.

### DETAILED DESCRIPTION

Examples described in this disclosure relate to systems and methods for generating context-aware, dynamic visualizations that are incorporated into a user interface of an application and/or an operating system. For example, dynamic context signals are extracted from different sources, such as applications, operating systems, and/or external devices. The dynamic context signals provide data about the current context of the device, such as location, weather, mailbox state, or other types of context that dynamically change over time. A dynamic visualization may then be generated based on the extracted context signals. For instance, an artificial intelligence (AI) prompt is generated that incorporates the extracted context signals and requests a generative AI model to generate a visualization based on the context signals. The generative AI model processes the AI prompt and generates an output payload that includes the visualization. The visualization is then processed and displayed as part of the user-interface for the application and/or operating system.

After a refresh period has expired, a new visualization is generated if the context signals have changed. Accordingly, the visualization aspect of the application dynamically changes as the context of the device's operation changes. The refresh period may be based on the particular context signals that are being used to generate the visualizations. For example, some context signals are unlikely to change in a frequent manner (e.g., seasons), whereas other context signals change more frequently (e.g., current weather).

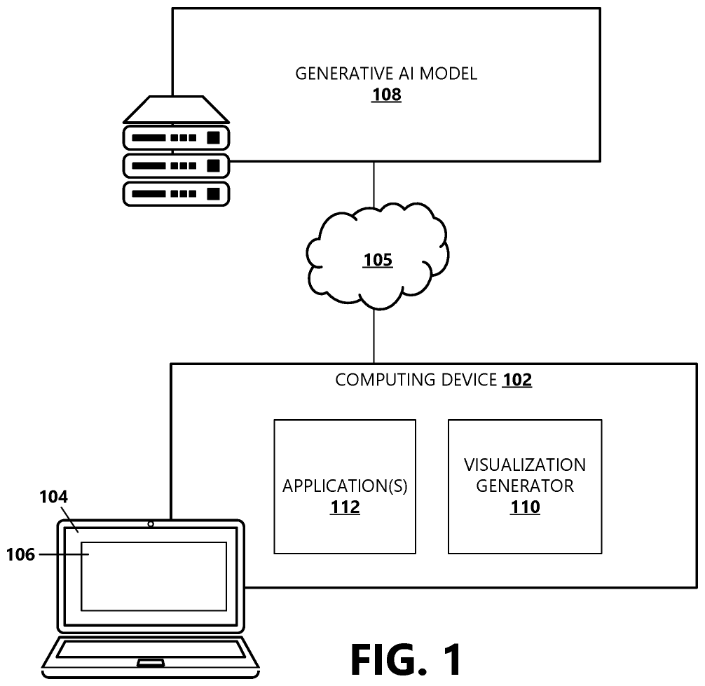

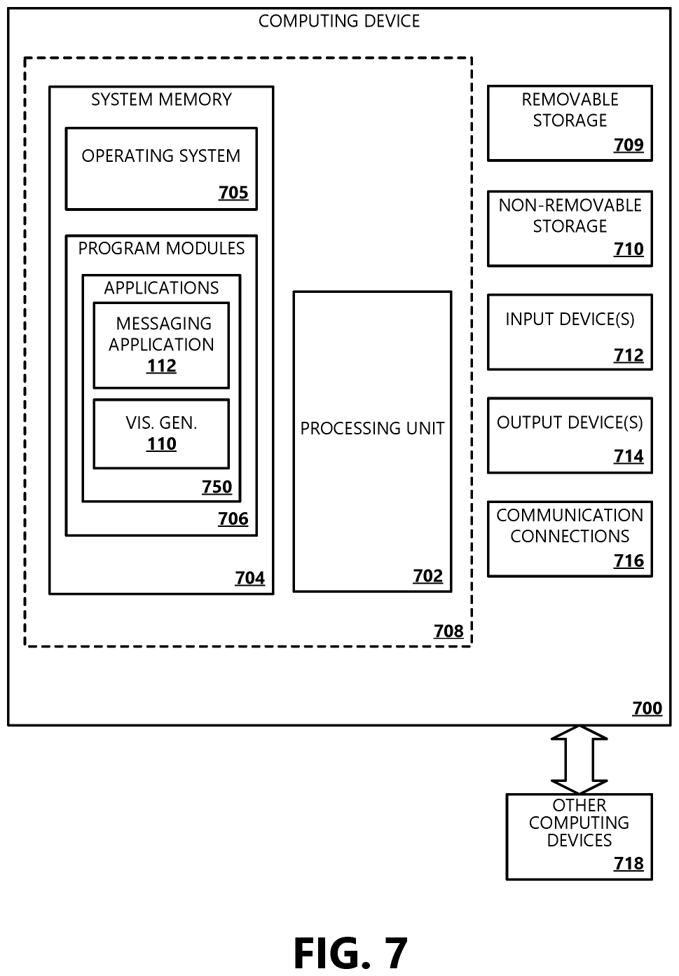

FIG. 1 is a block diagram of an example system 100 for generating context-aware, dynamic visualizations according to an example. The example system 100, as depicted, is a combination of interdependent components that interact to form an integrated whole. Some components of the system 100 are illustrative of software applications, systems, or modules that operate on a computing device or across a plurality of computer devices. Any suitable computer device(s) may be used, including web servers, application servers, network appliances, dedicated computer hardware devices, virtual server devices, personal computers, a system-on-a-chip (SOC), or any combination of these and/or other computing devices known in the art. In one example, components of systems disclosed herein are implemented on a single processing device. The processing device may provide an operating environment for software components to execute and utilize resources or facilities of such a system. An example of processing device(s) comprising such an operating environment is depicted in FIG. 7. In another example, the components of systems disclosed herein are distributed across multiple processing devices. For instance, input may be entered on a user device or client device and information may be processed on or accessed from other devices in a network, such as one or more remote cloud devices or web server devices.

The example system 100 generates visualizations using at least one generative AI model 108, which may be a large language model (LLM), a multimodal model, or other types of generative AI models. Example models may include the GPT models and DALL-E models from OpenAI, the Midjourney image-generation model from Midjourney, BARD from Google, the Firefly model from Adobe, and/or LLAMA from Meta, among other types of generative AI models. According to an aspect, the system 100 includes a computing device 102 that may take a variety of forms, including, for example, desktop computers, laptops, tablets, smart phones, wearable devices, gaming devices/platforms, virtualized reality devices/platforms (e.g., virtual reality (VR), augmented reality (AR), mixed reality (MR)), etc. The computing device 102 has an operating system that provides a graphical user interface (GUI) that allows users to interact with the computing device 102 via graphical elements, such as application windows (e.g., display areas), buttons, icons, and the like. For example, the graphical elements are displayed on a display screen 104 of the computing device 102 and can be selected and manipulated via user inputs received via a variety of input device types (e.g., keyboard, mouse, stylus, touch, spoken commands, gesture).

In examples, the computing device 102 includes a plurality of applications 112 for performing different tasks, such as communicating, information generation and/or management, data manipulation, visual construction, resource coordination, calculations, etc. One example application 112 may be a messaging application that operates to allow users to send and receive messages. Messages can be in various formats, such as text, audio, images, and/or video. Example messaging applications may include an email application, a messaging application, a chat application, a voicemail application, enterprise software, an information worker application, and the like. In some examples, the applications 112 may be productivity applications, such as word-processing applications, spreadsheet applications, task list applications, calendar applications, presentation applications, note-taking applications, time management applications, project management applications, etc.

The messaging application(s) 112 may be local applications or web-based applications accessed via a web browser. Each application 112 has one or more application UIs 106 by which a user can view and generate messages and interact with features provided by the messaging application 112. For example, an application UI 106 is presented on the display screen 104. In some examples, the operating environment is a multi-application environment by which a user may view and interact with multiple applications 112 through multiple application UIs 106.

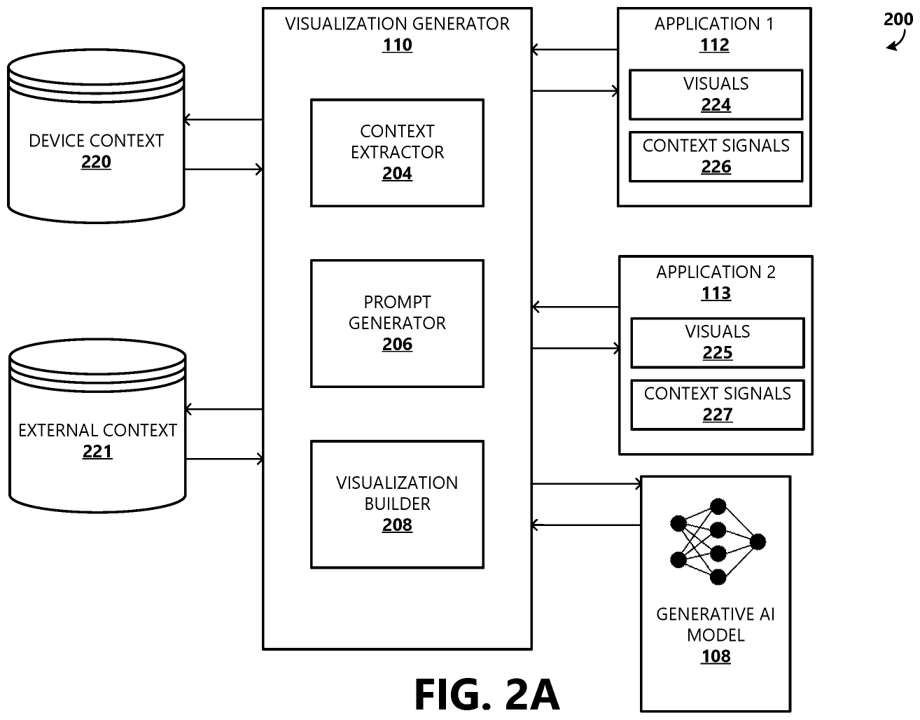

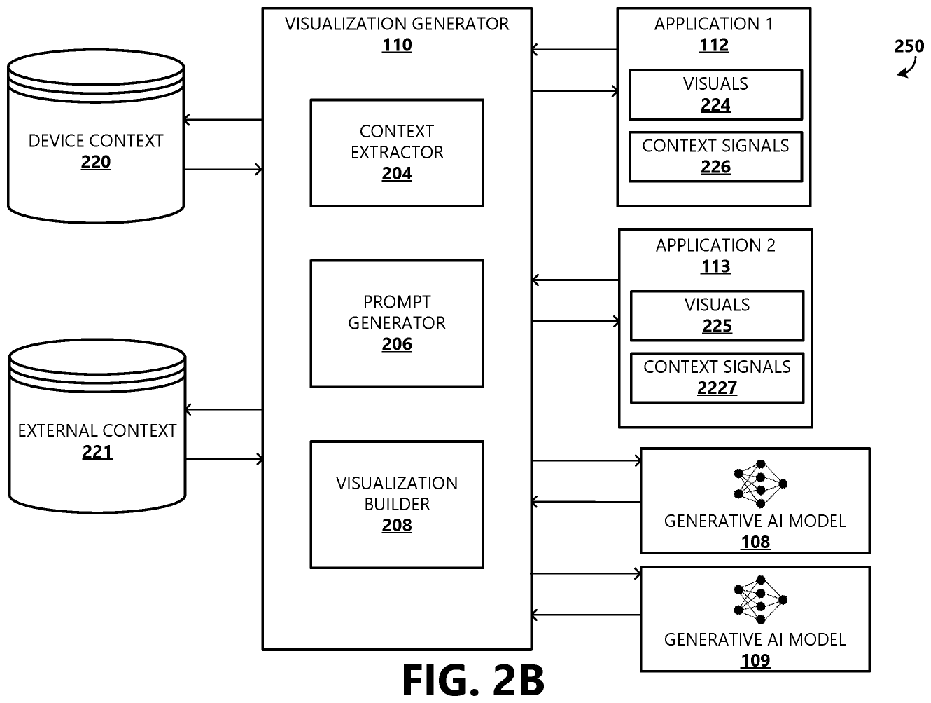

The system 100 further includes a context-aware, dynamic visualization generator 110. The visualization generator 110 utilizes context from applications 112 and/or from the device to dynamically generate visualizations for the user interfaces of the applications 112 and/or the operating system, as discussed further herein. For example, the visualization generator 110 may extract dynamic context signals and utilize those signals to generate one or prompts for the generative AI model(s) 108 that generate a visualization as output. The visualizations may be dynamically refreshed or generated as the context signals change. In one example, the context signal may include a weather signal that is indicative of the location of the device upon which the visualization generator 110 and/or applications 112 are operating. The weather context signal may then be incorporated into an AI prompt to cause a visualization indicative of the weather to be generated by the generative AI model 108. The generated visualization may then be incorporated into one or more of the applications 112 and/or an operating system of the device. A new AI prompt may be generated on a refresh cycle or trigger that has a frequency based on the type of context signal(s) used for initial prompt generation. These and other examples are described below in further detail with reference to FIGS. 2-7.

According to example implementations, the generative AI model 108 is trained to understand and generate sequences of tokens, which may be in the form of natural language (e.g., human-like text). In various examples, the generative AI model 108 can understand complex intent, cause and effect, perform language translation, semantic search classification, complex classification, text sentiment, summarization, summarization for an audience, and/or other natural language capabilities.

In some examples, the generative AI model 108 is in the form of a deep neural network that utilizes a transformer architecture to process the text it receives as an input or query. The neural network may include an input layer, multiple hidden layers, and an output layer. The hidden layers typically include attention mechanisms that allow the generative AI model 108 to focus on specific parts of the input text, and to generate context-aware outputs. The generative AI model 108 is generally trained using supervised learning based on large amounts of annotated text data and learns to predict the next word or the label of a given text sequence.

The size of a generative AI model 108 may be measured by the number of parameters it has. For instance, as one example of an LLM, the GPT-4 model from OpenAI has billions of parameters. These parameters may be weights in the neural network that define its behavior, and a large number of parameters allows the model to capture complex patterns in the training data. The training process typically involves updating these weights using gradient descent algorithms, and is computationally intensive, requiring large amounts of computational resources and a considerable amount of time. The generative AI model 108 in examples herein, however, is pre-trained, meaning that the generative AI model 108 has already been trained on the large amount of data. This pre-training allows the model to have a strong understanding of the structure and meaning of text, which makes it more effective for the specific tasks discussed herein.

The generative AI model 108 may operate as a transformer-type neural network. Such an architecture may employ an encoder-decoder structure and self-attenuation mechanisms to process the input data (e.g., the prompt). Initial processing of the prompt may include tokenizing the prompt into tokens that may then be mapped to a unique integer or mathematical representation. The integers or mathematical representations combined into vectors that may have a fixed size. These vectors may also be known as embeddings.

The initial layer of the transformer model receives the token embeddings. Each of the subsequent layers in the model may uses a self-attention mechanism that allows the model to weigh the importance of each token in relation to every other token in the input. In other words, the self-attention mechanism may compute a score for each token pair, which signifies how much attention should be given to other tokens when encoding a particular token. These scores are then used to create a weighted combination of the input embeddings.

In some examples, each layer of the transformer model comprises two primary sub-layers: the self-attention sub-layer and a feed-forward neural network sub-layer. The self-attention mechanism mentioned above is applied first, followed by the feed-forward neural network. The feed-forward neural network may be the same for each position and apply a simple neural network to each of the attention output vectors. The output of one layer becomes the input to the next. This means that each layer incrementally builds upon the understanding and processing of the data made by the previous layers. The output of the final layer may be processed and passed through a linear layer and a softmax activation function. This outputs a probability distribution over all possible tokens in the model's vocabulary. The token(s) with the highest probability is selected as the output token(s) for the corresponding input token(s).

In example implementations, the generative AI model 108 operates on a device located remotely from the computing device 102. For instance, the computing device 102 may communicate with the generative AI model 108 using one or a combination of networks 105 (e.g., a private area network (PAN), a local area network (LAN), a wide area network (WAN)). In some examples, the generative AI model 108 is implemented in a cloud-based environment or server-based environment using one or more cloud resources, such as server devices (e.g., web servers, file servers, application servers, database servers), personal computers (PCs), virtual devices, and mobile devices. The hardware of the cloud resources may be distributed across disparate regions in different geographic locations.

FIG. 2A is a block diagram of example components of an example context-aware, dynamic visualization system 200. The system 200 includes a visualization generator 110 that includes a content extractor 204, a prompt generator 206, and a visualization builder 208. The visualization generator 110 is in communication with a first application 112 and a second application 113 operating on a device. The visualization generator 110 is also in communication with a device context source 220 for context signals generated by, or available from, the computing device upon which the applications 112, 113 are operating. In addition, the visualization generator 110 is in communication with one or more external context sources 221 that may provide additional context signals. The external context source 221 may be a database that is accessible via a network, such as the Internet. The visualization generator 110 is also in communication with the generative AI model 108.

The visualization generator 110 may be a part of (e.g., a component of) the first application 112 and/or the second application 113. For instance, the visualization generator 110 may form a portion of the software code that defines the first application 112 and/or the second application 113. In other examples, the visualization generator 110 may be part of a separate service or application, such as a cloud-based service. In still other examples, the visualization generator may be part of the operating system.

The first application 112 includes a plurality of first visuals 224 that are displayed as part of the user interface of the first application 112. Similarly, the second application 113 includes a plurality of second visuals 225 that are displayed as part of the user interface of the second application 113. The first application 112 may also be a source for one or more first context signals 226 that are specific to the first application 112. The second application 113 may also be a source for one or more second context signals 227 that are specific to the second application 113.

The content extractor 204 of the visualization generator 110 extracts relevant context signals for ultimately generating visualizations to incorporate into the first visuals 224 of the first application 112 and/or the second visuals 225 of the second application 113. The context signals represent data about the context or operating state of the computing device and/or the applications running thereon. Extracting the context signals may include querying the respective context sources for the identified context signals and received a response to those queries that include data corresponding to the context signals. For instance, the content extractor 204 may generate and execute a query against the device context source 220, the external context source 221, the first application 112, and/or the second application 113. In other examples, one or more of the context source pushes the context signals to the content extractor 204.

The particular context signals that are extracted may be based on a particular theme that defines a preset group of context signals that are to be extracted and used to generate the visualizations. For example, a mailbox theme may primarily utilize context signals from a messaging application, such as an email application. In such examples where a mailbox theme is applied, the content extractor 204 extracts mailbox-based context signals from a messaging application, which may be the first application 112. The mailbox context signals may include signals such as the total number of unread messages (and/or read messages) within the mailbox of the user. The mailbox context may alternatively or additionally include data based on the content of messages (e.g., emails) in the mailbox. For instance, keywords, concepts, sender identifications, sentiments, or other data generated from the messages may be used as a context signal and extracted by the content extractor 204.

Calendar context signals may also be extracted from a calendaring application. For example, work hours and/or work location may be used as calendar context signals. Upcoming or current occasions, holidays, and/or events may also be extracted as context signals that may be used in the generation of the visualizations discussed herein.

In other examples a location theme and/or a weather theme may be selected for use. In a location theme, a location context signal may be extracted from the device context source 220. For instance, the device may include a global positioning sensor (GPS) that identifies the location of that device. That location may be used as a context signal that is extracted by the content extractor 204. The current time may also be extracted as a context signals from the device context source 220. In a weather theme, a weather context signal may be extracted from the external context source 221, such as real-time or current weather services that are accessible through the Internet. For example, the location received from the device context source 220 may be used to query the external context source 221 to receive the current weather or weather data that may be used as a context signal.

The weather data may be received from the external context source 221 in the form a weather object that indicates the daily weather. The weather object may include data including the date, high temperature, low temperature, weather caption, a weather icon, and a temperature unit. The weather caption may include descriptors such as sunny, cloudy, partly cloudy, mostly cloudy, fog, rain, rain showers, rain and snow, snow, light snow, snow showers, blowing snow, thunderstorm, squalls, dust storm, or blowing sand. The current season may also be extracted as part of the weather data and/or from a separate external context source 221.

The prompt generator 206 generates an AI prompt, for the generative AI model 108, that includes one or more of the context signals that are extracted by the content extractor 204. The AI prompt generally includes static portions and dynamic portions. The AI prompt may include instructions, in the form of static portions, that request the generative AI model 108 to generate visualizations based on the context signals. The dynamic portions of the AI prompt are populated with the context signals extracted by the content extractor 204. One example of an AI prompt template is provided below with the bracketed segments being dynamic content that is populated with the corresponding context signals:
Create a versatile render in Format 1 that vividly encapsulates a playful [weather caption] [season] in [location] at [time of day]. Be sure to consider the distinct atmospheric and lighting changes that occur from morning to night. Utilize a muted color palette that emanates serenity and tranquility, subtly capturing the ambiance of a [weather caption] [season] [time of day] in [location]. The composition should use accessible colors to create an inclusive, visually captivating scene. Infuse the scene with elements that represent a [weather caption] [season] [time of day] in [location], like iconic landmarks, seasonal features, and lively individuals enjoying the outdoors. With dynamic lighting, highlight the textures and reflections of the [weather caption], cityscape, and [season] elements, fostering an ambiance true to a [weather caption] [season] [time of day] in [location] at [time of day]. Experiment with a vibrant, accessible color palette that amplifies the playful character of the scene while maintaining a harmonious balance within the composition. Choose a muted background color that pairs well with the colorful elements and enhances the energetic, weather-inspired [season] [time of day] in [location]. This will be brought to life through the powerful capabilities of Format 1.”

In some examples, multiple AI prompt templates may be stored and/or accessed by the prompt generator 206. The different AI prompt templates correspond to the selected themes and/or the combination of context signals that are used for generating the visuals. For instance, a first AI prompt template may be used for a weather theme (e.g., using one or more weather context signals), a second AI prompt template may be used for a location theme (e.g., using one or more location context signals), and a third AI prompt template may be used for a mailbox theme (e.g., using mailbox state context signals). Other AI prompt templates may also be available for use and selection by the prompt generator 206 when generating the AI prompts discussed herein.

Once the AI prompt is generated, the prompt generator 206 provides the generated AI prompt to the generative AI model 108. The generative AI model 108 processes the AI prompt from the prompt generator 206 and provides an output payload with the data requested in the AI prompt. For instance, the output payload includes the visualization(s) requested by the AI prompt. The output payload is then received by the visualization generator 110.

The visualization builder 208 accesses and processes the output payloads from the generative AI model 108. For instance, the visualization builder 208 processes the visualizations generated from the generative AI model 108 to be incorporated into one of the first visuals 224 of the first application 112 and/or one of the second visuals 225 of the second application 113. As an example, the visualization builder 208 may format, resize, and/or crop the received visualization to fit a frame or user interface element of the first visuals 224 and/or second visuals 225. The visualization builder 208 may also extract dominant colors and/or color themes from the generated visualizations. Such colors may be incorporated into other user interface elements of the first application 112 and/or the second application 113.

The visuals 224 and/or 225 generated by the visualization builder 208 are then provided to the first application 112 and/or the second application 113 for display as part of the user interface of the respective application. In some examples, the visualizations generated by the generative AI model 108 may also or alternatively be incorporated into visuals for an operating system (e.g., background, wallpaper).

After a period of time (e.g., refresh period) according to the type of context signals, the first visuals 224 and/or the second visuals 225 may be refreshed by generating a new visualization from the generative AI model 108. The refresh period at which the visuals are generated may be based on the theme that is selected and/or the types of context signals that are used to generate the visualizations. Some context signals are more likely to change more frequently than others. For example, a current weather context signal may change somewhat rapidly and need to be refreshed every 30 minutes or hour. Other types of context signals, such as the current city, may need to be refreshed less often as the current city is unlikely to change quickly. Still other types of context signals may need to be refreshed even less frequently, such as the current season, which only changes every few months.

By adjusting the refresh rate based on the types of context signals used in the visualization generation, computing resources may be conserved by reducing the number of requests made to the generative AI model 108. For example, where the context signals are unlikely to change frequently, the frequency of the processing by the generative AI model 108 may be reduced to conserve the processing resources associated with executing the generative AI model 108.

FIG. 2B is a block diagram of example components of another example context-aware, dynamic visualization system 250. The example system 250 is similar to system 200 described above and depicted in FIG. 2A. Example system 250, however, includes a second generative AI model 109. The second generative AI model 109 may be a different type of model than the generative AI model 108. For example, the first generative AI model 108 may be a text-based model that receives text as input and produces text as output. The second generative AI model 109 may then be an image-generating or visualization-generating model. In other examples, both the models may be multi-model generative AI models that are capable of handling multiple types of inputs and generate multiple types of outputs.

In such an example, multiple prompts may be generated and used to generate the context-aware, dynamic visualizations discussed herein. For example, a first prompt may be used to augment the context signals that are extracted by the content extractor 204. The first prompt may be a request for the first generative AI model 108 to generate an augmented context signal that may then be used in a second prompt to request the visualizations from the second generative AI model 109. As one example, where a context signal includes a location, such as a city, the first prompt to the first generative AI model 108 may request additional information about the city, such as famous landmarks of the city. The first generative AI model 108 processes the first prompt and generates an output that includes the augmented context signal of the famous landmarks within the city or location.

The augmented context signal(s) that are received from the first generative AI model 108 may then be used by the prompt generator 206 to generate a second AI prompt that requests the visualization from the second generative AI model 109. Continuing with the example above, the second AI prompt includes the famous landmarks from the city that were received as output from the first generative AI model 108. Accordingly, the first AI prompt is used to generate augmented context signals from the first generative AI model 108, and those augmented context signals are incorporated into a second AI prompt to cause the second generative AI model 109 to generate a visualization based on the augmented context signals.

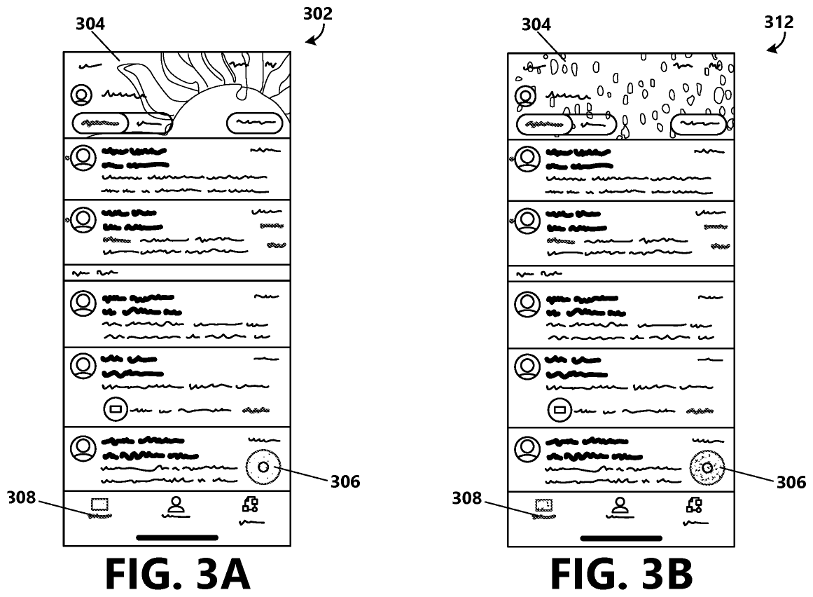

FIG. 3A depicts an example interface 302 including a context-aware, dynamic visualization. The example interface 302 is of a mobile-device messaging application (e.g., email application) that is displaying a plurality of message previews. At the top of the interface 302, a banner 304 is displayed with a first visualization that is generated from a generative AI model, as described further herein. In the example depicted, the visualization is of a sun representing sunny weather. The visualization was generated based on a context signal indicating the current weather at the location of the device is sunny.

Other user interface elements, such as icon 306 and text 308, may also be displayed in a particular color that matches or is based on the visualization generated by the generative AI model and displayed in the banner 304. In other examples, the color used for the display of the icon 306 and/or the text 308 may be based on the context signal used to generate the AI prompt and visualization. For example, the visualization builder 208 may apply a set of heuristics or rules against the context signals that provide a particular color. For instance, when the context signal indicates sun, the color may be red, yellow, or orange, and when the context signal indicates rain, the color may be blue or purple. The color may also be returned from the generative AI model where the AI prompt is configured to request a particular color that is representative of the context signals incorporated into the prompt.

FIG. 3B depicts another example interface 312 including context-aware, dynamic visualizations. The interface 312 is for the same messaging application as the interface 302. The interface 312 has, however, been dynamically updated with a new visualization in the banner 304 of the interface 312. For example, after a refresh period has passed, the weather context signal is updated (e.g., extracted again) and a new visualization based on the updated context signal is extracted. In the example depicted, the weather context signal has changed from sunny to rainy. Accordingly, a new AI prompt is generated with the updated context signal (e.g., rainy). That new AI prompt is provided as input to the generative AI model, and an updated visualization is generated as output from the generative AI model. The updated visualization is then formatted and/or populated into the banner 304 of the interface 312 to replace the prior visualization. The color of the other user interface elements (e.g., icon 306 and/or text 308) may also be updated to a color that matches the updated visualization displayed in the banner 304.

While the visualization generated from the generative AI model has been primarily discussed and shown as being incorporated into a banner of mobile messaging application, the visualization may be used and/or incorporated into other types of application user interfaces as well. The visualization may also be incorporated into user interface or display features of the operating system, such as a background or wallpaper that dynamically changes based on changing context signals.

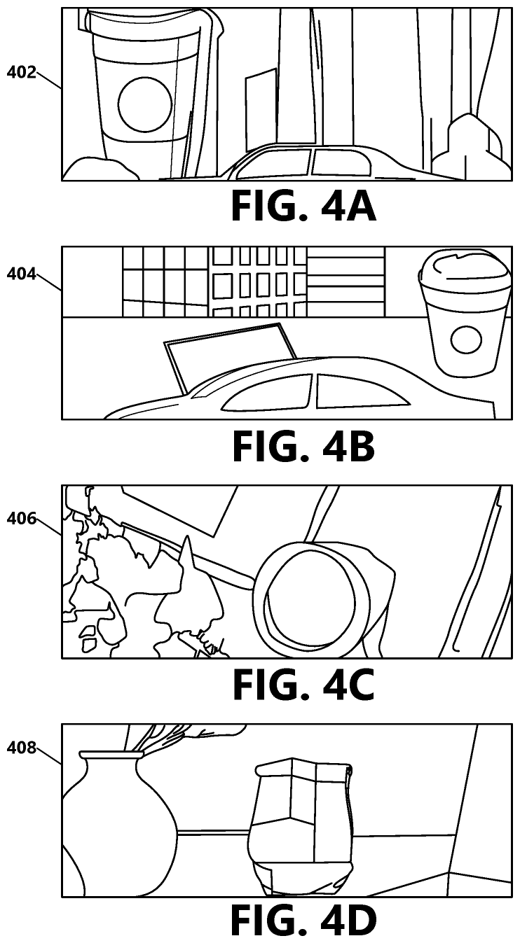

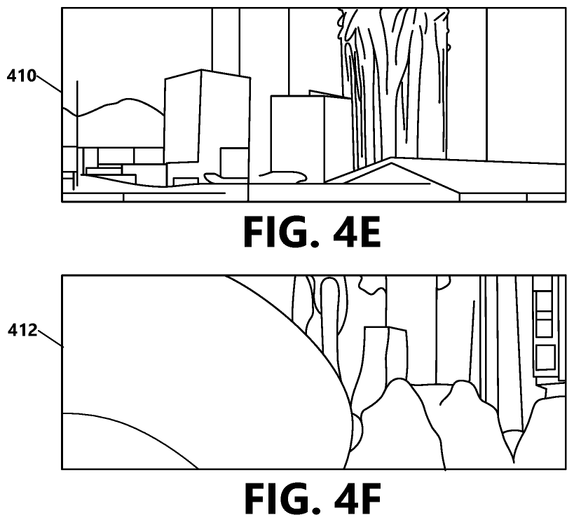

FIGS. 4A-F depicts example context-aware, dynamic visualizations for inclusion in an application. The visualizations are generated by a generative AI model using the processes discussed herein. FIG. 4A depicts a visualization 402 of a city including a coffee cup and a car. The visualization 404 may be based on a time and/or calendar context signal and location context signal indicating that the device is currently in a city, on a working day in the morning.

FIG. 4B also depicts a visualization 404 of a city, car, and coffee. The visualization 404 may be based on the same or similar context signals as the visualization 402 in FIG. 4A. Because the generative AI models may be non-deterministic (e.g., the same output may not be provided each time even for the same prompt) depending on the settings, different visualizations may be generated even for the same context signals or prompts. Such a minor randomness provides additional variety to the visualizations that are ultimately generated and incorporated in the applications.

FIG. 4C depicts another visualization 406. The visualization 4C depicts a coffee cup on a desk with a laptop. The visualization 406 may be based on context signals indicating a workday and a morning time. FIG. 4D depicts another visualization 408 that depicts an office scene, with a desk, a glass of water, and the corner of a laptop computer. This visualization may be based on the same type of context signals as the visualization 406 in FIG. 4C, but the context signals used to create the visualization 408 in FIG. 4 may indicate an afternoon time on a workday.

FIG. 4E depicts another visualization 410. The visualization 410 depicts a desert city scene, including a palm tree, with a sunrise on a sunny day. The visualization 410 may be based on context signals indicating time, location, and weather. For instance, the time may indicate morning, the location may indicate a desert city (e.g., Palm Springs), and the weather may indicate sunny. Incorporation of these context signals into an AI prompt causes the generative AI model to generate the visualization 410 shown in FIG. 4E.

FIG. 4F depicts another visualization 412. The visualization 412 includes an image of the Chicago Bean (e.g., “Cloud Gate”). The visualization 412 may be based on an augmented context signal generated from a first generative AI model. For example, the extracted context signal indicates that the device is currently located in Chicago. In the present example, that location context signal is incorporated into a first AI prompt that requests famous landmarks for Chicago. The first generative AI model processes the prompt and returns an output that includes the Chicago Bean. A second AI prompt is then generated that requests a visualization including the Chicago Bean. A second generative AI model processes the second AI input to generate the visualization 412.

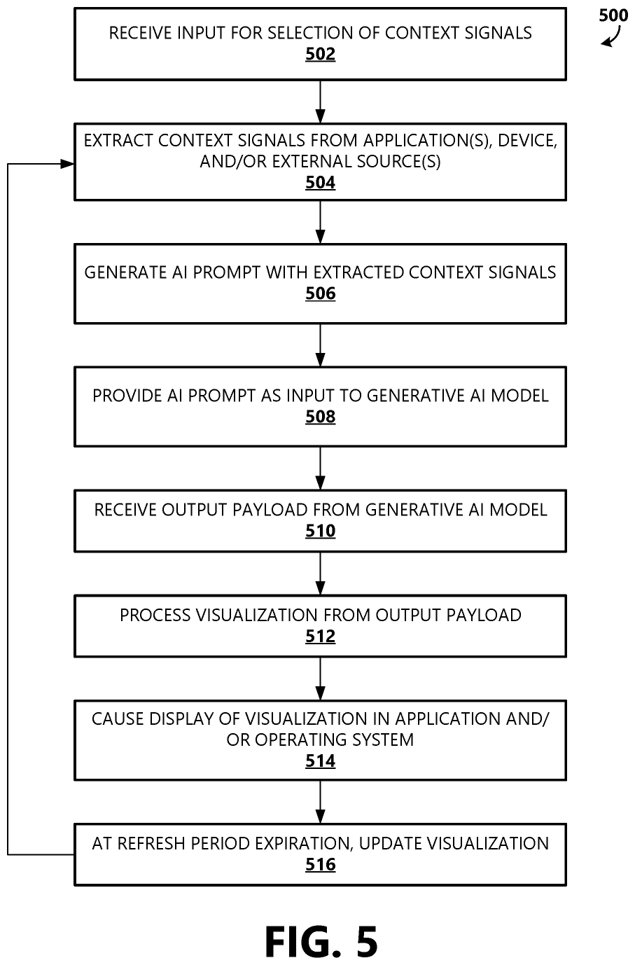

FIG. 5 depicts an example method 500 of generating context-aware, dynamic visualizations. The operations of method 500 may be performed by any of the components of the systems described above. For example, the operations may be performed by the visualization generator described above, which may be operating on a local device executing the applications or operating system and/or on a remote device or server that separate from the local device executing the applications or operating system. The respective device includes at least one processor and memory storing instructions that, when executed by the at least one processor, cause the device to perform one or more operations of method 500.

At operation 502, an input for a selection of context signals may be received. The input may be a user input that is received from an input device of the computing device (e.g., touch screen, voice input, mouse, keyboard). In an example, a listing of available context signals that can be used with the present visualization technology may be presented for selection. The user may then select the particular context signals that the user desires to be used for generating the visualizations. Relative weights may also be selected for each of the context signals. For instance, a user interface may be provided that allows the user to rank or set the relative importance of each of the context signals that are selected.

In some examples, some context signals should not be combined together and/or there may be a maximum number of context signals that should be combined together. For instance, the use of too many context signals may cause an overly complication visualization that may also provide a focus on a subtle or less important context signal. In addition, because mobile devices may often have limited display real estate, the generated visualization may be relatively small and too many details in the visualization may be difficult to see in the limited display real estate available. In some examples, instead of, or in addition to, a listing of available context signals, a listing of themes or groupings context signals may be displayed for selection. The groupings may provide more logical groupings of the context signals (e.g., weather and location) that have been shown to provide relatively clear visualizations. The groupings of context signals (e.g., themes) may also have predefined weights that indicate the relative weight or importance of the context signals within the grouping.

Operation 502 may also include receiving additional data from the user regarding stylistic preferences for the visualizations that are generated. For instance, stylistic data may indicate an art type, format, and/or genre for the visualizations that are generated.

At operation 504, the context signals that are selected or identified in operation 502 are extracted for further processing and/or inclusion into an AI prompt. Extraction of the context signals may include generating a query and executing the query against the respective database or data store to receive the context signal. For instance, to receive a current weather signal, a location of the device may first be queried, and then the current weather may be queried from an external database using the location of the device.

In some examples, the received context signals may be analyzed and/or parsed to extract the portion of the context signals that is incorporated into the AI prompt as dynamic content. For instance, as discussed above, a query for a weather context signal may return a weather object that contains multiple fields or types of data. Only one of those fields (e.g., the weather caption) may be used in the AI prompt. Accordingly, the weather object may be parsed to extract the weather caption that is used to populate the AI prompt.

At operation 506, an AI prompt is generated with the extracted context signals. For instance, the AI prompt may include static text and dynamic text. The dynamic text is populated with the extracted context signals to the form the AI prompt that is then provided to the generative AI model.

Operation 506 may also include selecting and/or accessing an AI prompt template from a plurality of AI prompt templates. The AI prompt template that is selected may be based on the context signals that were selected in operation 502. For example, a different AI template may be available for each different theme or grouping of context signals that is selected. The selected AI prompt includes dynamic text placeholders for the selected context signals (e.g., the context signals associated with the theme or the grouping of context signals). Different AI prompt templates may also be available for the different types of stylistic preferences provided by the user operation 502. Accordingly, the AI prompt template may be selected based on the contextual signals and/or the stylistic inputs received from the user. Once the AI prompt template is selected, the dynamic text placeholders are populated with the respective context signals to for the AI prompt.

At operation 508, the AI prompt is provided as input to the generative AI model. The generative AI model processes the received AI prompt and generates an output payload that includes a visualization according to the AI prompt. At operation 510, that output payload including the visualization is received.

At operation 512, the visualization in the output payload is processed. For example, the visualization may be sized and/or formatting to fit the particular portion of the application interface or operating system interface for which the visualization is to be displayed. At operation 514, the visualization is then caused to be displayed on as part of the user interface the respective application(s) and/or operating system running on the device. For instance, the visualization may be populated into the designated portion of the user interface, such as the banner of the messaging application discussed above.

At operation 516, at the expiration of a refresh period, the visualization is updated by performing operations 504-514 again with updated context signals. The refresh period may be specific to the context signals that were selected or identified in operation 502. For example, some context signals may be more likely to change in a shorter period of time than other context signals. For instance, a context signal of weather may change in a relatively short period of time, and the corresponding refresh period may be about 4 hours or less. Other context signals, such as season, change only once every few months. As such, that context signal need not be updated or refreshed on a daily interval. Accordingly, each theme or grouping of context signals may have an associated refresh period.

When the associated refresh period expires, some but not all of the utilized context signals may be refreshed or extracted again at operation 504 to receive updated context signals. For instance, in some examples, only the context signals that are likely to change within the refresh period are extracted again. In other examples, all the context signals are extracted again at the expiration of the refresh period.

The updated context signals may be compared to the previous context signals to determine if there was a change in the context signals. If the context signals did not change from when the prior visualization was generated, a new visualization may not be generated. As a result, the computing resources of processing a new AI prompt by the generative AI model are conserved when there has been no change in context. If there was a change in the context signals, another AI prompt is generated with the updated context signals to causes a new visualization to be generated by the generative AI model. That new visualization then replaces the initial visualization as part of the user interface of the application or operating system.

In some examples, in addition or alternatively to the refresh period, the context signals may be monitored for changes. When a change to the value for a context signal occurs, the refreshing of the visualization may occur, similarly to the triggering of the refreshing discussed above with respect to expiration of the refresh period.

While the above examples primarily utilizes generative AI models to generate the visualizations that are incorporated into the user interfaces, other mechanisms or techniques may also be used to generate the visualizations discussed herein. As an example, a database of images may be stored in a manner that allows for the images to be searched with, or based on, the context signals that are extracted. For instance, the images may include metadata and/or otherwise be tagged with data that include descriptors of the particular image. The metadata and/or tags may be configured to match or align with the categories of the different context signals that are being used. For example, images with rain may be tagged with “rain” or “rainy” to match the weather context signal that may be extracted. Accordingly, when the context signals are generated, a query may be executed against the database to retrieve one or more images that satisfy the query. A highest-ranking image may then be selected and used for the visualization that is incorporated into the user interfaces. As an example, operations 512 and 514 may be performed with the visualization extracted from the database. When the refresh period expires at operation 516, the visualization may be updated be again querying the database of images with the new or updated dynamic context signals to extract or retrieve another image from the database.

New images may also be added to the database over time and may include user-acquired images (e.g., images captured by a camera of the device). When the new image is added to the database, the image may be analyzed and tagged with the metadata discussed above. The analysis of the images may be performed using an AI and/or generative AI model to generate the metadata tags that match or align with context signals. For example, an AI prompt may be generated that requests a generative AI model to generate tags according to a set of different context signal categories. The generative AI model processes the new image with the prompt and generates an output payload that includes the tags. The tags may then be stored with the image (e.g., as metadata) in the database of images.

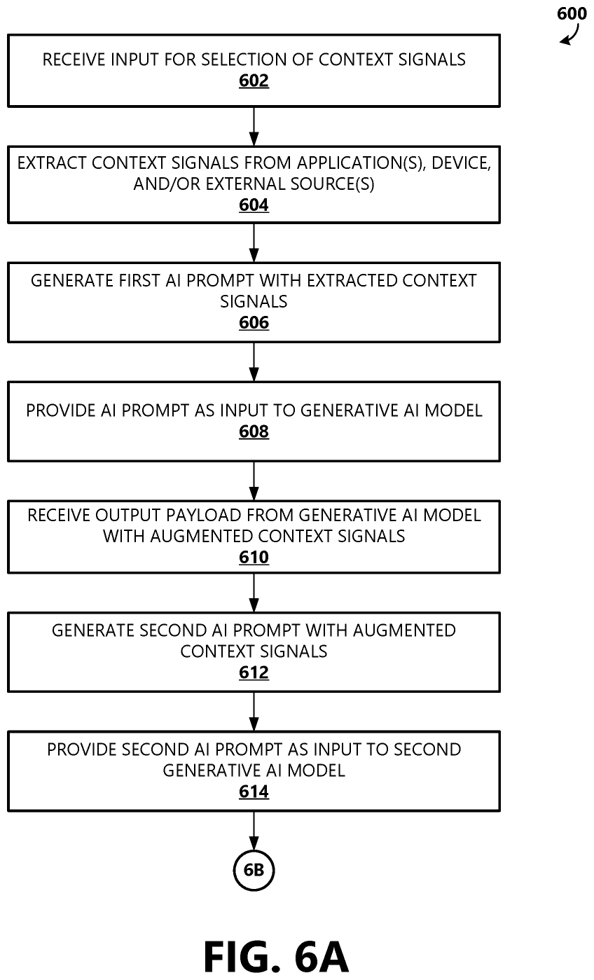

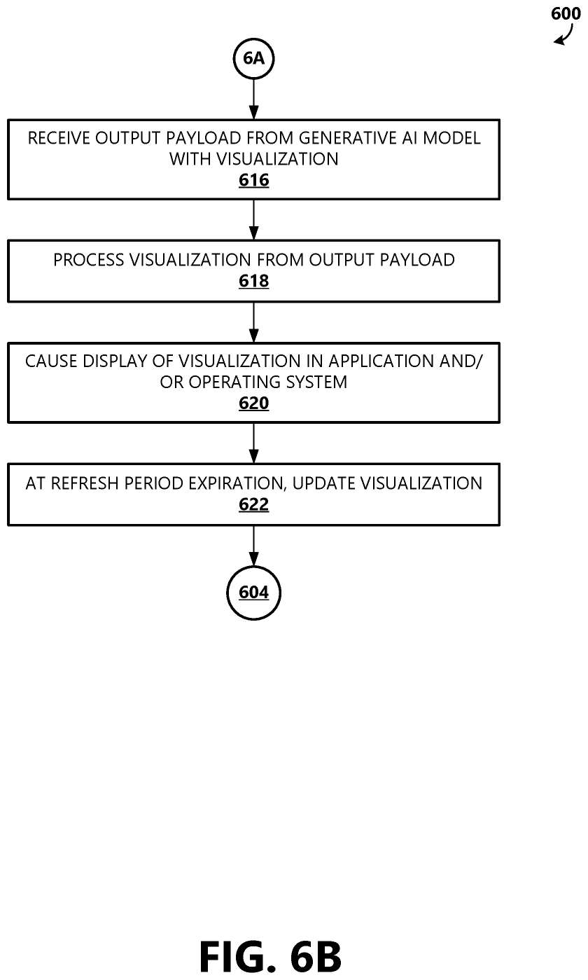

FIGS. 6A-B depict another example method 600 for generating context-aware, dynamic visualizations. The operations of method 600 may be performed by any of the components of the systems described above. For example, the operations may be performed by the visualization generator described above, which may be operating on a local device executing the applications or operating system and/or on a remote device or server that separate from the local device executing the applications or operating system. The respective device includes at least one processor and memory storing instructions that, when executed by the at least one processor, cause the device to perform one or more operations of method 600.

At operation 602, input is received for selection of context signals, and at operation 604, the selected context signals are extracted. Operations 602 and 604 may be the same as or substantially similar to operations 502-504 in method 500.

At operation 606, a first AI prompt is generated with the extracted context signals. Similar to operation 506 discussed above, multiple AI prompt templates may be available and a particular AI prompt may be selected based on the context signals being utilized and/or user input. The first AI prompt generated at operation 606 requests an augmented context signal to be generated from at least one of the context signals extracted in operation 604. As an example, the extracted context signal may include a location of the device (e.g., Chicago), and the first AI prompt may include instructions requesting famous landmarks for the location.

At operation 608, the first AI prompt is provided as input to a first generative AI model. The first generative AI model processes the first AI prompt and generates an output payload that includes the augmented context signal(s). At operation 610, that output payload with the augmented context signal(s) is received.

At operation 612, a second AI prompt is generated that includes the augmented context signal(s) received in the output payload from the first generative AI model. The second AI prompt requests a visualization based on the on the augmented context signal(s), and in some examples, one or more of the extracted context signals as well. Similar to the other AI prompts discussed herein, the second AI prompt may be based on an AI prompt template that is selected based on the context signals and/or the augmented context signals that are being utilized in the method 600 (e.g., the context signals selected at operation 602 and/or the augmented context signals received in the output payload). The dynamic portions of the selected AI prompt template are then populated with the augmented context signals and/or the extracted context signals to form the second AI prompt.

At operation 614, the second AI prompt is provided as input to a second generative AI model. In some examples, the second generative AI model is an image-generation model whereas the first generative AI model is text-generation model. The second generative AI model processes the second AI prompt and generates an output payload with the visualization. The output payload with the visualization is received at operation 616. At operation 618, the visualization is processed, and at operation 620 the visualization is displayed within the respective application(s) and/or operating system. At operation 622, at the expiration of the refresh period, the visualization may be updated by performing operations 604-620 again. Operations 614-622 may be substantially the same as operations 508-514 of method 500 described above.

FIG. 7 is a block diagram illustrating physical components (e.g., hardware) of a computing device 700 with which examples of the present disclosure may be practiced. The computing device components described below may be suitable for one or more of the components of the systems described above. In a basic configuration, the computing device 700 includes at least one processing unit 702 and a system memory 704. Depending on the configuration and type of computing device 700, the system memory 704 may comprise volatile storage (e.g., random access memory), non-volatile storage (e.g., read-only memory), flash memory, or any combination of such memories. The system memory 704 may include an operating system 705 and one or more program modules 706 suitable for running software applications 750 (e.g., one or more messaging applications 112 and/or visualization generators 110) and other applications.

The operating system 705 may be suitable for controlling the operation of the computing device 700. Furthermore, aspects of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 may perform processes including one or more of the stages of the methods 500 and 600, illustrated in FIG. 5-6. Other program modules that may be used in accordance with examples of the present disclosure and may include applications such as electronic mail and contacts applications, word processing applications, spreadsheet applications, database applications, slide presentation applications, drawing or computer-aided application programs, etc.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to detecting an unstable resource may be operated via application-specific logic integrated with other components of the computing device 700 on the single integrated circuit (chip). Examples of the present disclosure may also be practiced using other technologies capable of performing logical operations such as, for example, AND, OR, and NOT, including mechanical, optical, fluidic, and quantum technologies.

The computing device 700 may also have one or more input device(s) 712 such as a keyboard, a mouse, a pen, a sound input device, a touch input device, a camera, etc. The output device(s) 714 such as a display, speakers, a printer, etc. may also be included. The aforementioned devices are examples and others may be used. The computing device 700 may include one or more communication connections 716 allowing communications with other computing devices 718. Examples of suitable communication connections 716 include RF transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The system memory 704, the removable storage device 709, and the non-removable storage device 710 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer readable media may be part of the computing device 700. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

As should be appreciated from the foregoing, the technology disclosed herein provides multiple technical improvements and improvements to the corresponding computing devices and processes. The generation of the context-aware, dynamic visualizations and the incorporation into the user interfaces of productivity applications improves the functionality of the device by incorporating context signals from multiple sources within a single application. As an example, navigation between different applications may be avoided by using context signals from different sources or applications. For instance, with a weather-based visualization within a productivity application, there is no longer a need to perform app switching to a weather application. The technology increases the human-machine interface by providing a more insightful and welcoming interface for the user that resulted in further engagement with the device and/or application, resulting in device that further increases efficiency, speed, quality, and/or productivity of the work generated with the productivity application. Such insights further allow the user to orient his or her day without the need to view multiple applications or data sources-resulting in a further increase in productivity.

As should be appreciated from the foregoing, the technology discussed herein relates to multiple aspects and features. In an aspect, the technology relates to a computing device for generating context-aware, dynamic visualizations. The device includes at least one processor; and memory storing instructions that, when executed by the at least one processor, cause the device to perform operations. The operations include extract one or more dynamic context signals; generate an artificial intelligence (AI) prompt, based at least in part on the one or more dynamic context signals, requesting a visualization; provide the generated AI prompt as input to a generative AI model; in response to providing the AI prompt as input, receive an output payload from the generative AI model including the visualization; and cause a display of the visualization as part of a user interface of an application or an operating system operating on the computing device.

In an example, the operations further comprise, at an expiration of a refresh period, extract one or more updated dynamic context signals. In a further example, the refresh period is based on a type of the one or more dynamic context signals. In another example the operations further include: compare the updated context signals with the extracted context signals to determine that the updated context signals have changed; and based on determining that the updated context signals have changed, generate another AI prompt requesting another visualization based on the updated context signals. In still another example, the operations further include receiving a selection of the dynamic context signals to be used for generating the visualization. In yet another example, generating the AI prompt includes, based on the selected dynamic context signals, selecting a particular AI prompt template from a plurality of AI prompt templates, each of the AI prompt templates including static portions and dynamic portions; and populating the dynamic portions of the particular AI prompt template with the dynamic context signals to generate the AI prompt.

In another example, the context signals are extracted from at least one of the application, the operating system, the computing device, or an external source. In still another example, the context signals include at least one of a location context signal or a weather context signal. In yet another example, the context signals include a mailbox context signal.

In another aspect, the technology relates to a computer-implemented method for generating context-aware, dynamic visualizations. The method includes extracting a dynamic context signal; generating a first artificial intelligence (AI) prompt including the dynamic context signal; providing the first AI prompt as input to a first generative AI model; in response to providing the first AI prompt as input, receiving an output payload from the first generative AI model including an augmented context signal; generating a second AI prompt based at least in part on the augmented context signal; providing the second AI prompt as input to a second generative AI model; in response to providing the second AI prompt as input, receiving an output payload from the second generative AI model including a visualization; and causing a display of the visualization in at least one of a user interface of an application or an operating system operating on a computing device.

In an example, generating the first AI prompt includes: based on the dynamic context signal, selecting a particular AI prompt template from a plurality of AI prompt templates, each of the AI prompt templates including a static portion and a dynamic portion; and populating the dynamic portion of the particular AI prompt template with the dynamic context signal to generate the first AI prompt. In another example, generating the second AI prompt includes: based on the augmented context signal, selecting a particular AI prompt template from a plurality of AI prompt templates, each of the AI prompt templates including a static portion and a dynamic portion; and populating the dynamic portion of the particular AI prompt template with the augmented context signal to generate the second AI prompt. In a further example, the context signal includes at least one of a location context signal, a weather context signal, or a mailbox context signal. In yet another example, the second AI prompt also includes the extracted context signal. In still another example, the augmented context signal includes additional information related to the extracted context signal. In still yet another example, the method further includes, at an expiration of a refresh period, re-extracting the dynamic context signal and generating an updated visualization based on the re-extracted dynamic context signal.

In another aspect, the technology relates to a computer-implemented method for generating context-aware, dynamic visualizations. The method includes extracting a dynamic context signal; based on the dynamic context signal, retrieving a first visualization; causing a display of the first visualization as part of an application user interface; at an expiration of a refresh period, extracting an updated dynamic context signal; based on the updated dynamic context signal, retrieving a second visualization; and replacing the first visualization with the second visualization as part of an application user interface.

In an example, retrieving the first visualization includes generating a first query based on the dynamic context signal; executing the first query against a database of images; and receiving, in response to the first query, a first image as the first visualization. In a further example, retrieving the second visualization includes generating a second query based on the updated dynamic context signal; executing the second query against the database; and receiving, in response to the second query, a second image as the second visualization. In another example, retrieving the first visualization includes generating a first artificial intelligence (AI) prompt including the dynamic context signal; providing the first AI prompt as input to a generative AI model; in response to providing the AI prompt as input, receiving an output payload from the generative AI model including the first visualization; and retrieving the second visualization includes generating a second artificial intelligence (AI) prompt including the updated dynamic context signal; providing the second AI prompt as input to the generative AI model; and in response to providing the AI prompt as input, receiving an output payload from the generative AI model including a second visualization. In still yet another example, the method further includes comparing the updated context signal with the initially extracted context signal to determine that the updated context signal changed from the initially extracted context signal.

It is to be understood that the methods, modules, and components depicted herein are merely examples. Alternatively, or in addition, the functionality described herein can be performed, at least in part, by one or more hardware logic components. For example, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. Likewise, any two components so associated can also be viewed as being “operably connected,” or “coupled,” to each other to achieve the desired functionality. Merely because a component, which may be an apparatus, a structure, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

The functionality associated with some examples described in this disclosure can also include instructions stored in a non-transitory media. The term “non-transitory media” as used herein refers to any media storing data and/or instructions that cause a machine to operate in a specific manner. Illustrative non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with transmission media. Transmission media is used for transferring data and/or instruction to or from a machine. Examples of transmission media include coaxial cables, fiber-optic cables, copper wires, and wireless media, such as radio waves.

Furthermore, those skilled in the art will recognize that boundaries between the functionality of the above-described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A computing device for generating context-aware, dynamic visualizations, the device comprising:
at least one processor; and
memory storing instructions that, when executed by the at least one processor, cause the device to perform operations comprising:
extract one or more dynamic context signals;
generate an artificial intelligence (AI) prompt, based at least in part on the one or more dynamic context signals, requesting a visualization;
provide the generated AI prompt as input to a generative AI model;
in response to providing the AI prompt as input, receive an output payload from the generative AI model including the visualization; and
cause a display of the visualization as part of a user interface of an application or an operating system operating on the computing device.

2. The computing device of claim 1, wherein the operations further comprise, at an expiration of a refresh period, extract one or more updated dynamic context signals.

3. The computing device of claim 2, wherein the refresh period is based on a type of the one or more dynamic context signals.

4. The computing device of claim 2, wherein the operations further comprise:
compare the updated context signals with the extracted context signals to determine that the updated context signals have changed; and
based on determining that the updated context signals have changed, generate another AI prompt requesting another visualization based on the updated context signals.

5. The computing device of claim 1, wherein the operations further comprise receiving a selection of the dynamic context signals to be used for generating the visualization.

6. The computing device of claim 5, wherein generating the AI prompt comprises:
based on the selected dynamic context signals, selecting a particular AI prompt template from a plurality of AI prompt templates, each of the AI prompt templates including static portions and dynamic portions; and
populating the dynamic portions of the particular AI prompt template with the dynamic context signals to generate the AI prompt.

7. The computing device of claim 1, wherein the context signals are extracted from at least one of the application, the operating system, the computing device, or an external source.

8. The computing device of claim 1, wherein the context signals include at least one of a location context signal or a weather context signal.

9. The computing device of claim 1, wherein the context signals include a mailbox context signal.

10. A computer-implemented method for generating context-aware, dynamic visualizations, the method comprising:
extracting a dynamic context signal;
generating a first artificial intelligence (AI) prompt including the dynamic context signal;
providing the first AI prompt as input to a first generative AI model;
in response to providing the first AI prompt as input, receiving an output payload from the first generative AI model including an augmented context signal;
generating a second AI prompt based at least in part on the augmented context signal;
providing the second AI prompt as input to a second generative AI model;
in response to providing the second AI prompt as input, receiving an output payload from the second generative AI model including a visualization; and
causing a display of the visualization in at least one of a user interface of an application or an operating system operating on a computing device.

11. The method of claim 10, wherein generating the first AI prompt comprises:
based on the dynamic context signal, selecting a particular AI prompt template from a plurality of AI prompt templates, each of the AI prompt templates including a static portion and a dynamic portion; and
populating the dynamic portion of the particular AI prompt template with the dynamic context signal to generate the first AI prompt.

12. The method of claim 10, wherein generating the second AI prompt comprises:
based on the augmented context signal, selecting a particular AI prompt template from a plurality of AI prompt templates, each of the AI prompt templates including a static portion and a dynamic portion; and
populating the dynamic portion of the particular AI prompt template with the augmented context signal to generate the second AI prompt.

13. The method of claim 10, wherein the context signal includes at least one of a location context signal, a weather context signal, or a mailbox context signal.

14. The method of claim 10, wherein the second AI prompt also includes the extracted context signal.

15. The method of claim 10, wherein the augmented context signal includes additional information related to the extracted context signal.

16. The method of claim 10, further comprising, at an expiration of a refresh period, re-extracting the dynamic context signal and generating an updated visualization based on the re-extracted dynamic context signal.

17. A computer-implemented method for generating context-aware, dynamic visualizations, the method comprising:
extracting a dynamic context signal;
based on the dynamic context signal, retrieving a first visualization;
causing a display of the first visualization as part of an application user interface;
at an expiration of a refresh period, extracting an updated dynamic context signal;
based on the updated dynamic context signal, retrieving a second visualization; and
replacing the first visualization with the second visualization as part of an application user interface.

18. The method of claim 17, wherein:
retrieving the first visualization comprises:
generating a first query based on the dynamic context signal;
executing the first query against a database of images; and
receiving, in response to the first query, a first image as the first visualization; and
retrieving the second visualization comprises:
generating a second query based on the updated dynamic context signal;
executing the second query against the database; and
receiving, in response to the second query, a second image as the second visualization.

19. The method of claim 17, wherein:
retrieving the first visualization comprises:
generating a first artificial intelligence (AI) prompt including the dynamic context signal;
providing the first AI prompt as input to a generative AI model;
in response to providing the AI prompt as input, receiving an output payload from the generative AI model including the first visualization; and
retrieving the second visualization comprises:
generating a second artificial intelligence (AI) prompt including the updated dynamic context signal;
providing the second AI prompt as input to the generative AI model; and
in response to providing the AI prompt as input, receiving an output payload from the generative AI model including a second visualization.

20. The method of claim 17, further comprising comparing the updated context signal with the initially extracted context signal to determine that the updated context signal changed from the initially extracted context signal.
